(19) United States
(12) Patent Application Publication
(10) Pub. No.: US 2003/0095761 A1
(43) Pub. Date: May 22, 2003

(54) SONET/sdh section tracer

(76) Inventors: Alan D. Nisbet, Ottawa (CA); Rodney J. Berg, Nepean (CA); Kevin G. Estabrooks, Fall River (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/988,433

(22) Filed: Nov. 20, 2001

(51) Int. Cl. G02B 6/44

(52) U.S. Cl. 385/100

(57) ABSTRACT

A computer program is provided for determining and displaying fiber connectivity along a line of a SONET network. The computer program logs into each network element in the line and sets a section trace transmit value for each circuit pack group (CPG). The computer program then logs into each network element in the line, and reads the value of a received section trace value of each circuit pack group. The fiber connectivity is displayed using a data structure which allows crossed fibers to be seen readily by displaying the section trace transmit value and the section trace received value of CPGs in neighbouring network elements. The computer program allows the fiber connectivity along the line to be determined quickly, and crossed fibers to be noticed easily.

### FIELD OF THE INVENTION

This invention relates to optical communication networks, and more particularly to determination of fiber connectivity within such networks.

### BACKGROUND OF THE INVENTION

In optical communication networks that employ Synchronous Optical Network (SONET), a four layer architecture is used as a high bit rate transport method between customer end points. A photonic layer deals with the transport of bits across a physical medium. A section layer manages communication between adjacent network elements. A line layer manages communication between SONET devices other than regenerators. A path layer manages communication over a path bounded by customer end points. A payload originates at one end of a path and terminates at the other end of the path.

A line (or maintenance span) is a length of communication path bounded by Line Terminating Equipment (LTE) and managed by the line layer. An Add-Drop Multiplexer (ADM) is an example of an LTE. A section is a length of uninterrupted fiber bounded by any type of network element, including ADMs and regenerators, and is managed by the section layer. A line consists of one or more sections. For example, a line containing no regenerators will have one section, whereas a line containing one regenerator will have two sections.

Each section contains fibers between the network elements bounding the section. Each fiber is connected to a Circuit Pack Group (CPG) within each of the two bounding network elements. A CPG may be a single card, or may be a virtual CPG if more than one fiber is coupled to the card. The term “CPG” will be used herein to refer to both types of CPG, so that each fiber is connected to a different CPG in a network element. Each CPG within a network element has a unique identifying number (e.g. G1, G2).

Ideally, the fibers are connected to CPGs in an orderly and consistent manner. However, there may be as many as sixteen fibers along one section, and it is possible for two fibers to be pulled from their respective CPGs within a network element and then inadvertently reinserted in to the incorrect CPGs. This results in the fibers becoming crossed. If fibers become crossed, an alarm signal is generated by the network elements. If the line contains only one section (i.e. the line contains only two network elements, each of which is an LTE) then the alarm signal will indicate clearly which fibers are crossed. However, if the line contains more than one section, then it is unclear from the alarm signal which fibers are crossed. In the example of a two-section line containing a regenerator and two ADMS, the fibers could be crossed between the first ADM and the regenerator, or between the regenerator and the second ADM. A network engineer must then trace the fiber connectivity along the length of the line from the first ADM to the second ADM to determine which CPGs of each network element along the line are linked to which CPGs in adjacent network elements.

The SONET data format offers a solution. The base signal in SONET is referred to as Synchronous Transport Signal-Level 1 (STS-1) and operates at 51.84 Mbps. Higher rate signals are referred to as STS-N signals, where N is an integer, and an STS-N signal operates at a rate of N*51.84 Mbps, with each of the N STS-1 frames being byte interleaved. Each STS-1 frame contains a transport overhead and a synchronous payload envelope (SPE). The transport overhead contains a section overhead and a line overhead. The SPE contains an STS path overhead and a payload.

Each overhead allows operations, administration, maintenance and provisioning (OAM&P) related to a different layer within the optical network. The section overhead allows OAM&P relating to the section layer. The third byte of the section overhead of the each STS-1 of the STS-N frame is a section trace byte, referred to as the J0 byte. There is no standard format for the contents of the J0 byte. In order to determine the fiber connectivity of a section, a network engineer logs into a first network element. Using a command line interface (CLI), the operator sets the J0 byte of a frame to have a value identifying the network element and the CPG to which the fiber is connected. The operator logs out of the first network element and logs into a second network element to which the first network element is connected, and uses the CLI of the second network element to determine at which CPG in the second network element frames from the CPG in the first network element arrived.

In order to determine the fiber connectivity along a line made up of several sections, the operator must repeat the above process for each CPG within each network element along the line. This process is tedious and time consuming, particularly if there are many fibers connecting each network element, as in a four fiber ring network. Furthermore, keeping track of the connections between CPGs as fiber connectivity is discovered is complicated. Both of these difficulties will intensify as the size of optical networks grows.

### SUMMARY OF THE INVENTION

The present invention provides a computer program product for determining fiber connectivity along a line of a Synchronous Optical Network, the line having at least two network elements (NEs), each NE having at least one Circuit Pack Group (CPG). The computer program product is a computer-readable medium including instructions readable by a processor. Each CPG is configured to enable section tracing. A section trace transmit value of each CPG is populated with a section trace identifier value unique to the CPG. A section trace received value of each CPG is read. The original user configuration of each CPG may be restored.

The present invention also provides a method of displaying fiber connectivity between a first network element (NE) and a second NE of a Synchronous Optical Network, each NE including at least one Circuit Pack Group (CPG). Each CPG is either an upstream CPG or a downstream CPG. A section trace transmit value of each CPG of the first NE is read. A section trace received value of each CPG of the first NE is read. Equipment information which identifies the first NE is displayed. Section trace information is displayed, the section trace information including at least one section trace block. Each section trace block corresponds to one CPG in the first NE, and includes the section trace transmit value and the section trace received value of the CPG to which the section trace block corresponds. The section trace blocks are arranged so that the section trace blocks corresponding to upstream CPGs appear on a first side of the section trace information and section trace blocks corresponding to downstream CPGs appear on a second side of the section trace information. The method may be implemented by a processor reading instructions from a computer-readable medium.

The instructions which make up the two computer programs may be combined into a single computer program, with the various values stored in and read from memory.

The computer program product provides a reliable and efficient method of determining fiber connectivity along a line within an optical communication network. The computer program product also provides a method of displaying fiber connectivity in a manner that allows a network engineer to quickly determine in which section of a line fibers are crossed.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The invention will now be described in greater detail with reference to the accompanying diagrams, in which:

FIG. 1 is a block diagram of an example optical communication network in which the invention is implemented;

FIG. 2 is a flowchart of a method of determining and displaying fiber connectivity along a line;

FIG. 3 is a block diagram of a network topology of the network shown in FIG. 1;

FIG. 4 is a flowchart of a method of configuring Circuit Pack Groups (CPGs) along a line of an optical network;

FIG. 5 is an example output of a Network Element User Interface (NEUI) “qr” command;

FIG. 6 is an output of an NEUI “eq ne qrne” command;

FIG. 7 is a flowchart of a method of reading section trace received values along a line of an optical network;

FIG. 8 is a flowchart of a method of resetting the configuration of CPGs along a line of an optical network;

FIG. 9 is a data structure used to display section trace information for a network element; and

FIG. 10 is an example of data structures for two network elements in a four fiber ring network.

### DETAILED DESCRIPTION OF THE PREFERRED EMBODIMENTS

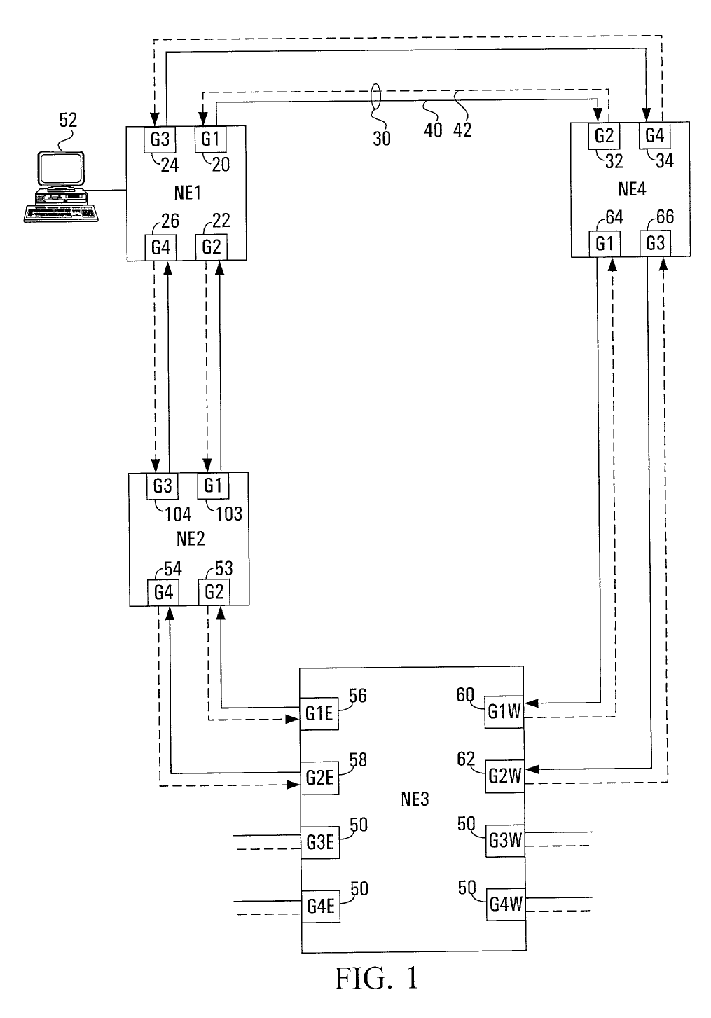

Referring to FIG. 1, an example optical communication network is shown. The network of FIG. 1 is a 4-fiber bi-directional line switched ring. The network includes four network elements NE1, NE2, NE4, and NE3. Network elements NE1, NE2 and NE4 are Add-Drop Multiplexers (ADMs), while network element NE3 is a regenerator. NE1 has four Circuit Pack Groups (CPGs) G1 20, G2 22, G3 24, and G4 26. A CPG is a card inserted into a slot of a shelf in a network element, although more generally a CPG may be a virtual CPG. Each CPG is coupled to a fiber, each of which is in turn coupled to a CPG in another network element so that the CPGs on one network element are connected to the CPGs on another network element on a one-to-one basis. For example, CPG G1 20 of NE1 is coupled to a CPG G2 32 in NE4 via a fiber 30. The fiber 30 provides bi-directional communication between G1 20 of NE1 and G2 32 of NE4. A first signal travels along the fiber 30 in a downstream direction 40 from NE1 to NE4, and a second signal travels along the fiber 30 in an upstream direction 42 from NE4 to NE1.

Similarly, each of the other network elements NE2, NE3, and NE4 are interconnected through CPGs and fibers. Furthermore, NE3, which is a regenerator, is coupled to a second 4-fiber bi-directional line switched ring (not shown) through additional CPGs 50. Each CPG in each network element which transmits a signal along a fiber in the upstream direction is referred to as an upstream CPG. Each CPG in each network element which transmits a signal along a fiber in the downstream direction is referred to as a downstream CPG. The configuration of the network shown in FIG. 1 is for illustration purposes only, and the invention may be implemented in any optical network.

A computer 52 is coupled to NE1, though more generally the computer 52 may be coupled to any of the network elements. The computer 52 may be coupled to NE1 via a TCP/IP connection using telnet, or by a direct serial connection through an RS-232 port on NE1. The computer 52 includes a section trace tool, in the form of software stored in memory or on a computer-readable memory device such as a magnetic disk or a CD-ROM. The section trace tool interacts with the network by logging in to and out of the network elements, either directly in the case of NE1 or indirectly over OAM & P signalling in the case of NE2, NE3, or NE4. Once logged in to a network element, the section trace tool interacts with the network element by issuing Network Element User Interface (NEUI) commands. NEUI commands will differ from manufacturer to manufacturer. The NEUI commands given in this description are particular to network elements manufactured by Nortel Networks Limited. Network elements manufactured by other companies respond to different NEUI commands, but NEUI commands having the same functionality as the NEUI commands given in this description exist for all SONET compliant network elements.

ADMs are types of line-terminating equipment (LTE), while regenerators are not. There are therefore three lines in the network shown in FIG. 1: from NE1 to NE2, from NE2 to NE4 through NE3, and from NE4 to NE1. Fiber connectivity is normally determined between LTEs separated by more than one section. Accordingly, in the network shown in FIG. 1, the section trace tool would determine the fiber connectivity along the line between NE2 and NE4 through NE3. The fiber connectivity would be determined across each section which makes up the line, namely between NE2 and NE3 and between NE3 and NE4. The section trace tool could also determine the fiber connectivity between NE1 and NE2 or between NE4 and NE1, but this would be of less use as the alarm signal generated as a result of crossed fibers is such that the CPGs to which the crossed fibers are connected are identified when the crossed fibers directly connect two LTEs.

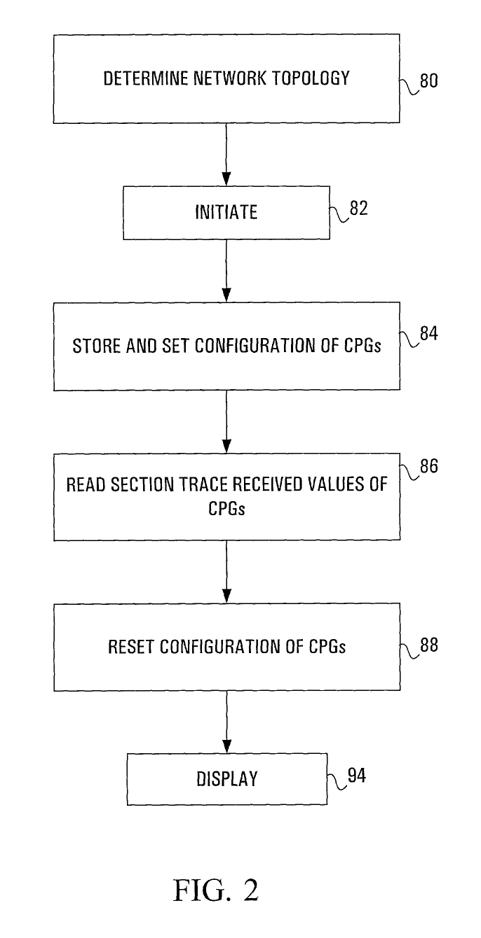

Referring to FIG. 2, a flowchart of a method by which the fiber connectivity along a line is determined and displayed is shown. At step 80 a network engineer determines the topology of the network. The topology indicates which network elements are connected to which other network elements, and through which CPGs. However, the topology does not indicate which CPGs in one network element are connected to which CPGs in a neighbouring network element. The topology may be determined using a method described in U.S. Patent Application entitled “Method and Apparatus for Creating a SONET Network Plot”, filed Dec. 21, 2000 by Alan Nisbet and Kevin Estabrooks, assigned to Nortel Networks Limited, and incorporated by reference herein. The topology is represented by data structures which are stored either in memory or on a computer-readable medium.

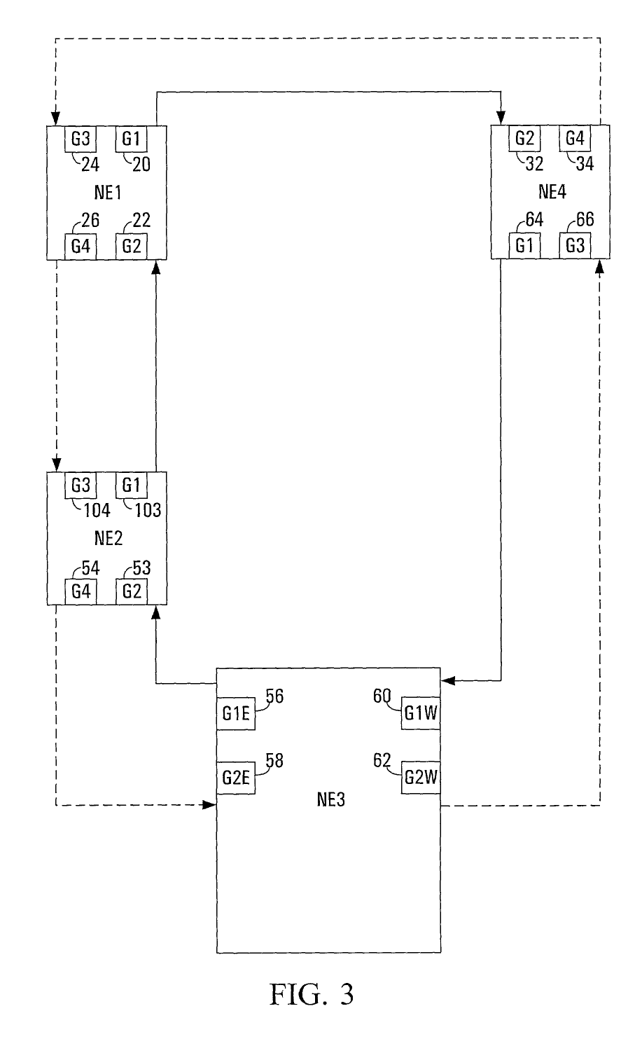

Referring to FIG. 3, the topology of the network shown in FIG. 1 is shown, as determined at step 80 of FIG. 2. For the line from NE2 through NE3 to NE4, the topology indicates that these network elements are connected to each other, and also indicates that NE2 is connected to NE3 through CPGs G2 53 and G4 54 to CPGs G1E 56 and G2E 58, but does not indicate to which of G1E 56 or G2E 58 G2 53 is connected and to which of G1E 56 or G2E 58 G4 54 is connected. Similarly, NE3 is shown connected to NE4, but the connections between the CPGs G1W 60, G2W 62, G1 64 and G3 66 are not shown. The topology also indicates that NE3 is upstream from NE2, and that NE4 is upstream from NE3.

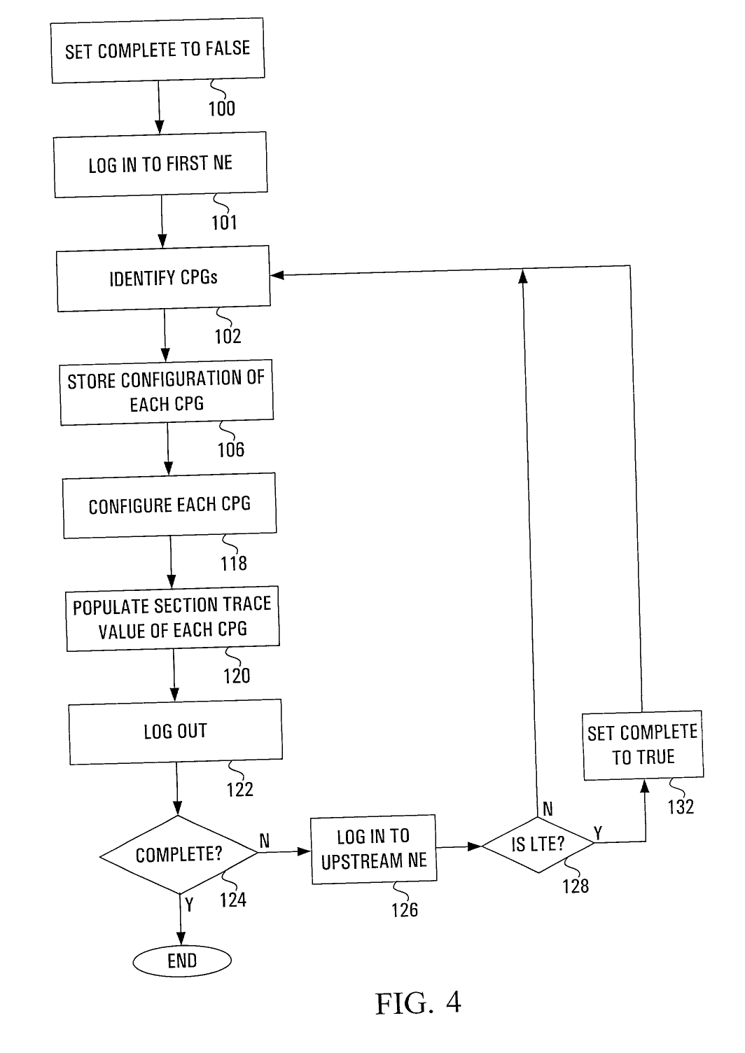

Returning to FIG. 2, once the topology has been determined, the network engineer initiates the section trace tool at step 82 by providing as input an identification of the first network element of a line along which the fiber connectivity is to be determined. This must be the downstream LTE, as the section trace tool will determine fiber connectivity in the upstream direction until it encounters another LTE, as described below with reference to FIG. 4, 6 and 7. In the example of this description, the network engineer identifies NE2 as the first network element of the line.

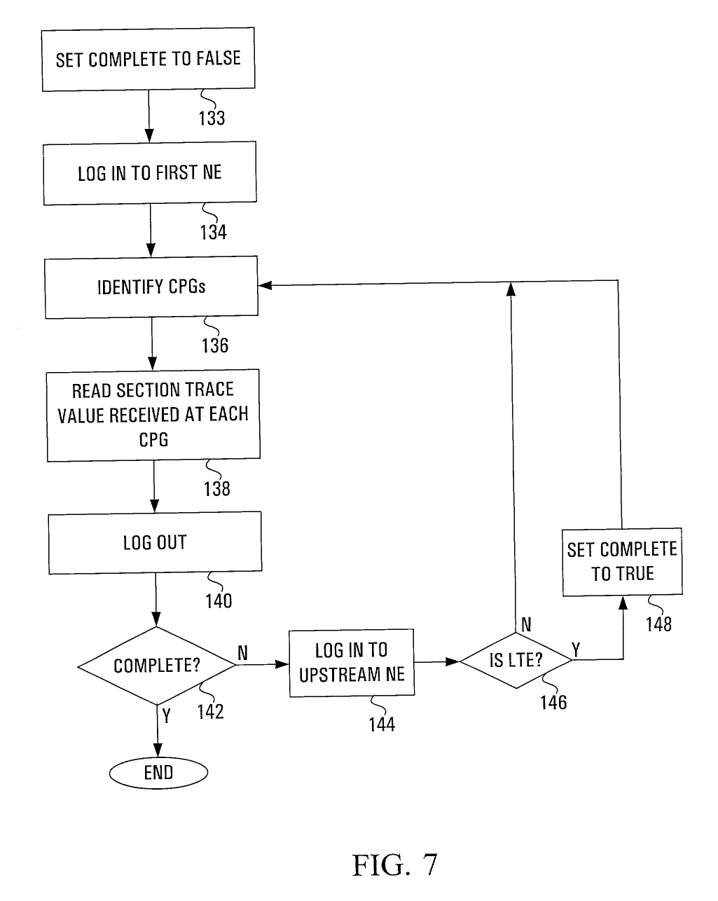

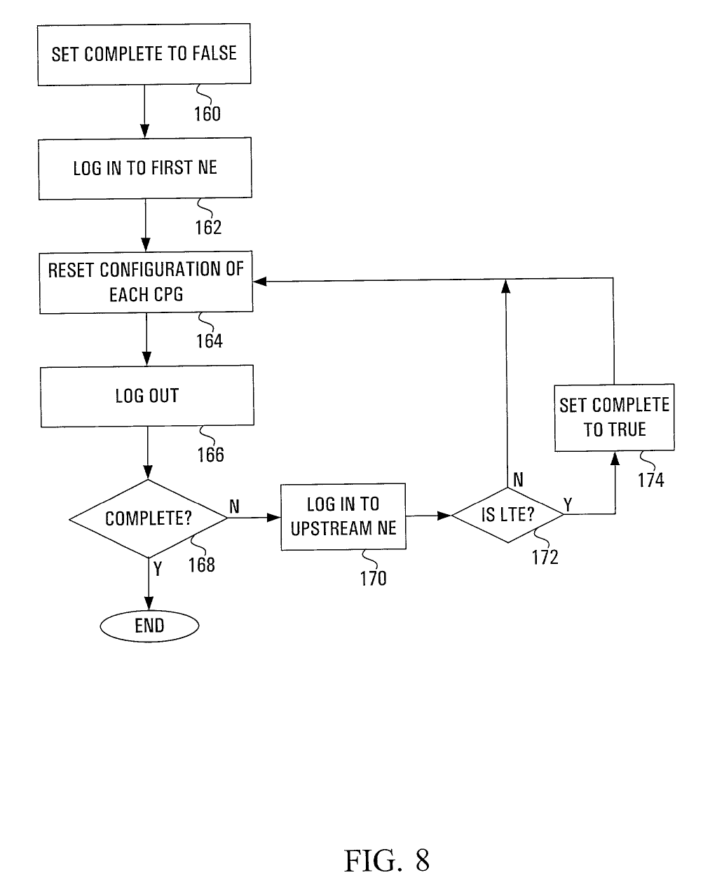

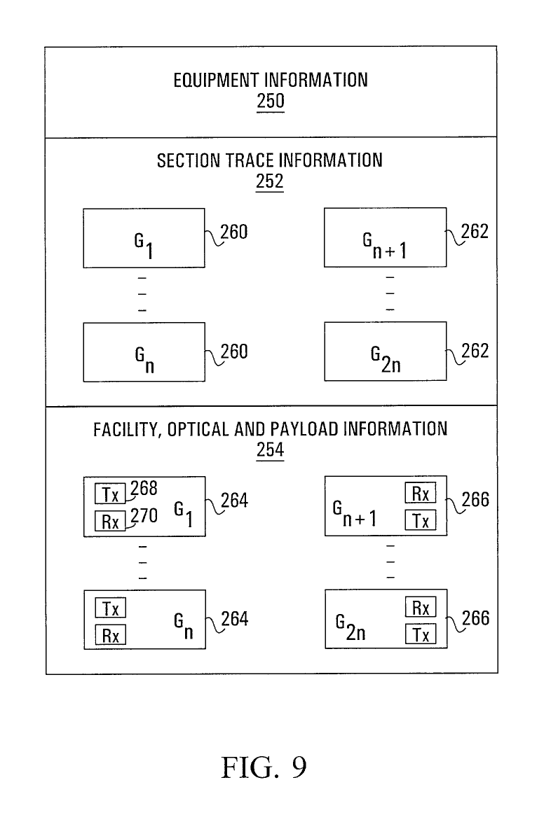

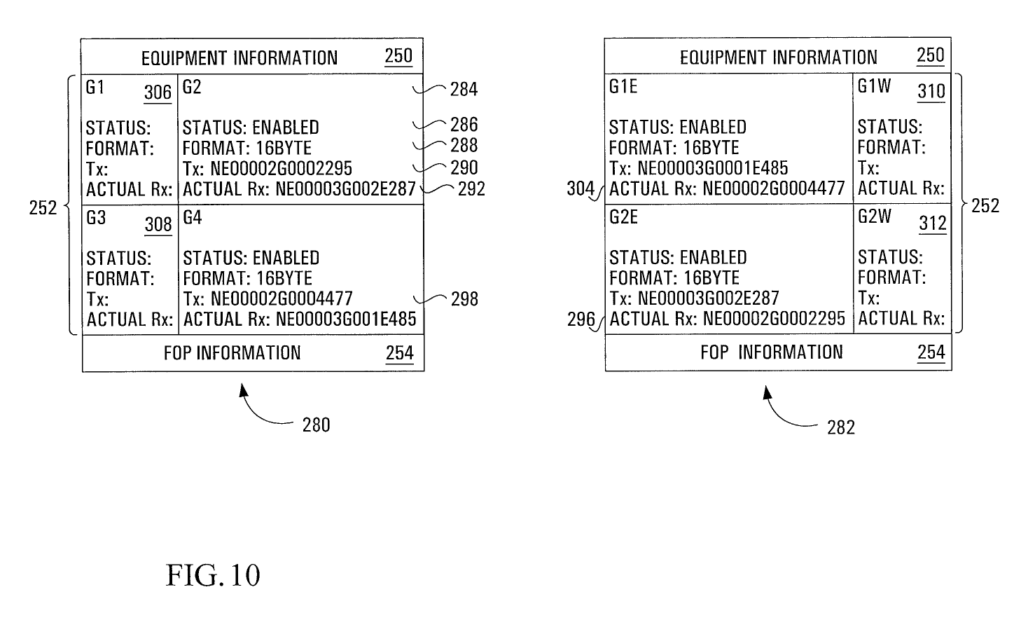

At step 84 the section trace tool determines and stores an original user configuration (set by the owner of the network) of each CPG along the line, and configures each CPG along the line to a configuration that is usable by the section trace tool. Step 84 is described in further detail below with reference to FIG. 4. At step 86 the section trace tool reads section trace received values received at each CPG along the line, as described in further detail below with reference to FIG. 7. At step 88 the section trace tool resets the configuration of each CPG along the line to the original user configuration that was determined at step 84, so that the section trace tool can determine the fiber connectivity in a non-intrusive manner. Step 88 is described in further detail below with reference to FIG. 8. A display tool displays the fiber connectivity at step 94, using a data structure described below with reference to FIG. 9 and FIG. 10. The display tool is software stored in memory or on a computer-readable medium, and executed by a computer, possibly the same computer 52 that contains the section trace tool.

Referring to FIG. 4, a flowchart of a method carried out by the section trace tool to configure each CPG along a line (step 84 of FIG. 2) is shown. At step 100, the section trace tool sets a flag to false. The flag is used by the section trace tool to indicate whether the CPGs have been configured along the entire line. At step 101, the section trace tool logs into the first network element, which will be the network element identified by the network engineer during initiation at step 82 of FIG. 2. At step 102 the section trace tool determines the upstream CPGs and the downstream CPGs. These are determined from the network topology data structures generated at step 80 of FIG. 2. In the example of this description, the section trace tool determines that the upstream CPGs within NE2 are G2 53 and G4 54, and determines that the downstream CPGs within NE2 are G1 103 and G3 104.

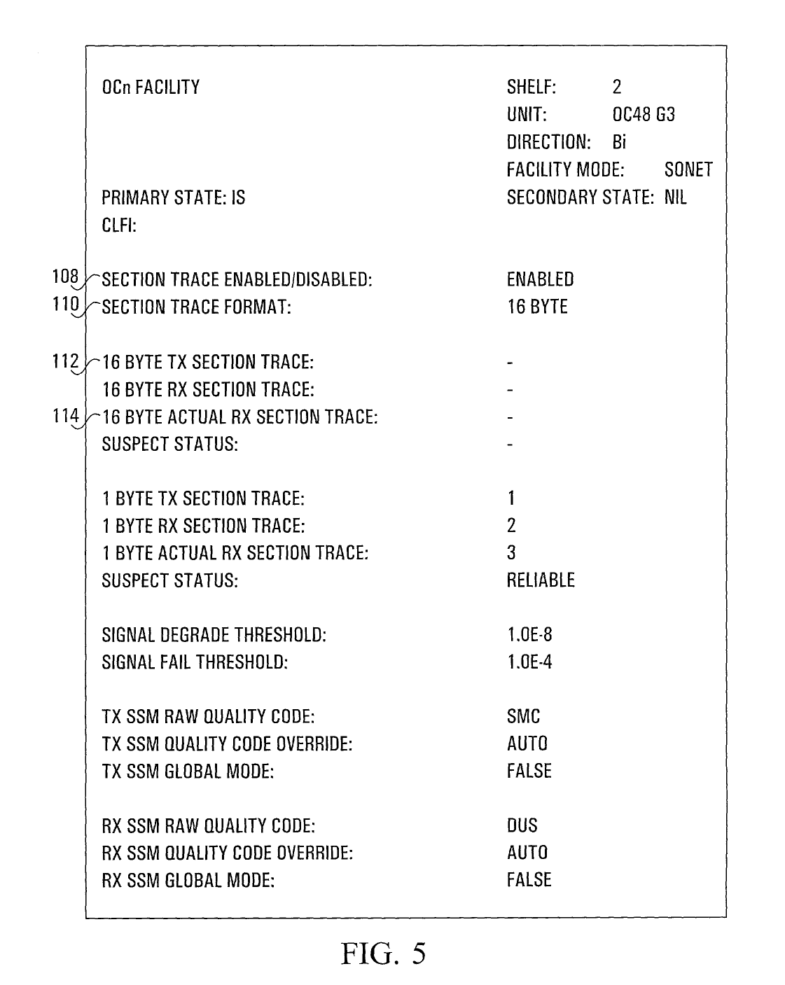

At step 106 the section trace tool determines and stores an original user configuration of each upstream CPG and of each downstream CPG within the network element. The section trace tool queries the network element using a NEUI “fa ocf sel <facility type> <facility name>qr” command line string (referred to hereinafter as a “qr” command), where “<facility type>” is a parameter having a value identifying the type of CPG (for example, “OC192”), and “<facility name>” is a parameter having a value identifying the name of the CPG (for example, “G2”). In response to the “qr” command, the network element provides the section trace tool with a “qr” output. An example of a “qr” output is shown in FIG. 5. The “qr” output lists information about the CPG identified by the value of the <facility name>parameter. The “qr” output includes a Section Trace Mode 108 and a Section Trace Format 110. The Section Trace Mode 108 has a value that indicates whether section tracing is enabled or disabled. The Section Trace Format 110 has a value that indicates the length of the data that is placed in the section trace bytes of the STS-1 frames. The “qr” output also includes a 16-Byte Transmit Section Trace value 112 and a 16-Byte Actual Received Section Trace value 114, which are empty in the example “qr” output of FIG. 5.

The section trace tool parses the “qr” output to determine the value of the Section Trace Mode 108, the value of the Section Trace Format 110, and the 16-Byte Transmit Section Trace value 112 for the CPG identified in the “qr” command. These three values make up the original user configuration of the CPG. The original user configuration of each CPG is stored, either in memory or in a datafile, for use when the section trace tool resets the configuration of the CPG at step 88 of FIG. 2.

Returning to FIG. 4, at step 118 the section trace tool configures each upstream CPG and each downstream CPG to enable section tracing and to set the length of the data that is placed in the section trace bytes of the STS-1 frames. The section trace tool issues a NEUI “fa ocf sel <facility type> <facility name>ed stm” command (referred to hereinafter as an “stm” command) for each upstream CPG and each downstream CPG, where “<facility type>” is a parameter identifying the type of CPG and “<facility name>” is a parameter identifying the name of the CPG. The “stm” command allows the section trace tool to set the value of the Section Trace Mode 108 of the specified CPG. In response to the “stm” command, the network element prompts the section trace tool to provide a value of either “disable” or “enable”. The section trace tool provides the value “enable”. The network element prompts the section trace tool to confirm that the value “enable” is correct. The section trace tool provides the character “y” followed by a carriage return.

The section trace tool issues a NEUI “fa ocf sel <facility type> <facility name>ed stf” command (referred to hereinafter as an “stf” command) for each upstream CPG and each downstream CPG, where “<facility type>” is a parameter identifying the type of CPG and “<facility name>” is a parameter identifying the name of the CPG. The “stf” command allows the section trace tool to set the value of the Section Trace Format 110 of the specified CPG. In response to the “stf” command, the network element prompts the section trace tool to provide a value of either “1 byte” or “16 byte”. The section trace tool provides the value “16 byte”. The network element prompts the section trace tool to confirm that the value “16 byte” is correct. The section trace tool provides the character “y” followed by a carriage return.

The section trace tool sets a section trace transmit value of each upstream CPG and of each downstream CPG at step 120. The section trace tool issues a NEUI “fa ocf sel <facility type> <facility name>ed txst” command (referred to hereinafter as a “txst” command) for each upstream CPG and each downstream CPG. In response to the “txst” command, the network element prompts the section trace tool to provide a section trace identifier value. The section trace tool provides a formatted string that identifies the network element, the CPG, and a wavelength at which transmission from the CPG occurs. The section trace identifier value is preferably a fifteen character string that uses seven characters to identify the network element, five characters to identify the CPG, and the three remaining characters to identify the wavelength. For example, if the wavelength identification for signals from G2 53 to G1E 56 was “295”, then the section trace identifier value for the connection from G2 53 in NE2 to G1E 56 in NE3 would be “NE00002G0002295”. As the Section Trace Format 110 has been set to “16 byte”, there is an additional byte which is reserved for future use. For example, if the CPGs contain ports, the additional byte could be used to identify a port number. After the section trace tool provides the fifteen character formatted string, the network element prompts the section trace tool to confirm that the section trace identifier value is correct. The section trace tool provides the character “y” followed by a carriage return. The section trace tool stores the fifteen character section trace identifier in a datafile for later use by the display tool.

Once the section trace tool has confirmed that the section trace identifier value is correct, the CPG will set the 16-Byte Transmit Section Trace value 112 to have the same value as the section trace identifier. Any subsequent STS-N frames transmitted through the upstream CPG will carry the 16-Byte Transmit Section Trace value 112. Because the Section Trace Format 110 has a value of “16Byte” and each STS-1 frame has room for only one byte in its J0 byte, the sixteen bytes of the 16-Byte Transmit Section Trace value 112 (the fifteen bytes of the section trace identifier plus the one reserved byte) are spread over sixteen STS-1 frames of the STS-N frame.

At step 122 the section trace tool logs out of the current network element (NE2 in the example of this description). At step 124 the section trace tool determines whether the value of the flag is true, in order to determine whether all the CPGs along the line have been configured. If the value of the flag is false (i.e. not all the CPGs along the line have been configured), then at step 126 the section trace tool logs in to the next upstream network element (NE3 in the example of this description) as determined from the topology.

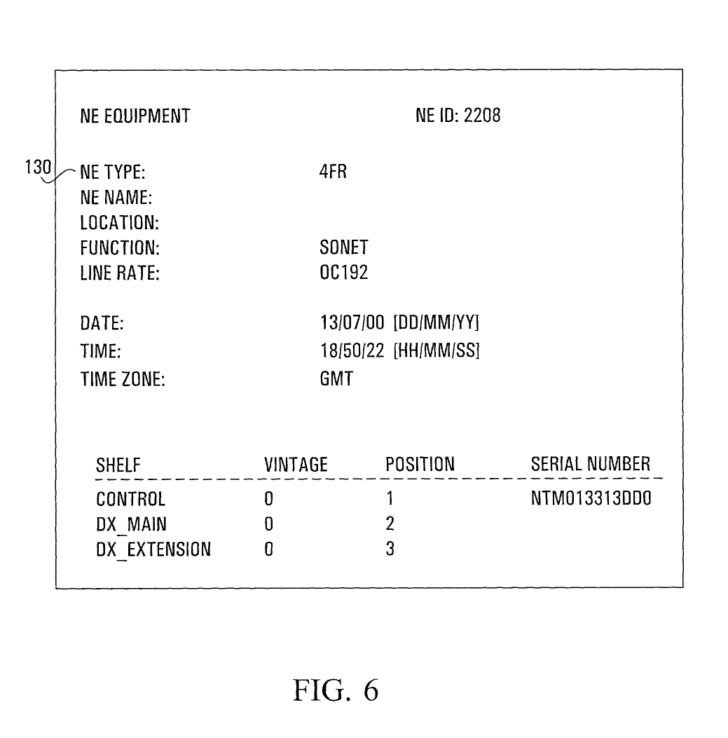

At step 128 the section trace tool determines whether the network element to which it is currently logged in is an LTE, by issuing a NEUI “eq ne qrne” command. In response to the “eq ne qrne” command, the network element provides a “eq ne qrne” output, an example of which is shown in FIG. 6. The “eq ne qrne” output includes a Network Element Type value 130. The section trace tool parses the “eq ne qrne” output to determine the Network Element Type value 130. A network element which is an LTE will have a well known Network Element Type value 130, such as “4FR”. A network element which is not an LTE will have a well known Network Element Type value 130, such as “REGEN”.

If the section trace tool determines at step 128 that this network element is an LTE, then this network element is the last network element of the line, and the section trace tool sets the value of the flag to be true at step 132. The section trace tool then configures the CPGs in this network element by returning to step 102. If the section trace tool determines at step 128 that this network element is not an LTE, then the section trace tool configures the CPGs in this network element by returning to step 102, without changing the value of the flag.

After the section trace tool has configured the CPGs in the last network element in the line, the value of the flag will be false at step 124, and the section trace tool will have finished configuring all CPGs of all the network elements along the line. The section trace tool then reads section trace received values received at each CPG along the line, at step 86 in FIG. 2.

Referring to FIG. 7, a flowchart of a method carried out by the section trace tool to read section trace received values for each CPG along a line (step 86 of FIG. 2) is shown. At step 133, the section trace tool sets a flag to false, as described above with reference to step 100 of FIG. 4. At step 134, the section trace tool logs into the first network element, which will be the network element identified by the network engineer during initiation at step 82 of FIG. 2. At step 136 the section trace tool determines the upstream CPGs and the downstream CPGs, as described above with reference to step 102 of FIG. 4. Alternatively, the identification of the upstream CPGs and of the downstream CPGs of this network element could have been stored, in memory or in a datafile, after they were identified at step 102 of FIG. 4.

For each upstream and each downstream CPG identified at step 136, the section trace tool determines at step 138 the 16-Byte Actual Received Section Trace value 114 received at the CPG, by issuing a “qr” command, as described above with respect to step 106 of FIG. 4. The section trace tool parses the “qr” output to determine the 16-Byte Actual Received Section Trace value 114 of the CPG, and stores the value in a datafile for later use by the display tool. The 16-Byte Actual Received Section Trace value 114 will contain the fifteen character string that was placed at step 120 in the 16-Byte Transmit Section Trace value 112 of a CPG to which the CPG is connected in a neighbouring network element.

At step 140 the section trace tool logs out of the network element. At step 142 the section trace tool determines whether the value of the flag is true, in order to determine whether the section trace received values of all the CPGs along the line have been read. If the value of the flag is false (i.e. the section trace received values of all the CPGs along the line have not been read), then at step 144 the section trace tool logs in to the next upstream network element as determined from the topology.

At step 146 the section trace tool determines whether the network element to which it is currently logged in is an LTE, as described above with reference to step 128 of FIG. 4. If the section trace tool determines at step 146 that this network element is an LTE, then this network element is the last network element of the line, and the section trace tool sets the value of the flag to be true at step 148. The section trace tool then reads the section trace received values of the CPGs in this network element by returning to step 136. If the section trace tool determines at step 146 that this network element is not an LTE, then the section trace tool reads the section trace received values of the CPGs in this network element by returning to step 136, without changing the value of the flag.

After the section trace tool has read the section trace received values of the CPGs in the last network element in the line, the value of the flag will be false at step 142, and the section trace tool will have finished reading the section trace received values of the CPGs in all the network elements along the line. The section trace tool then resets the configuration of each CPG along the line, at step 88 in FIG. 2.

Referring to FIG. 8, a flowchart of a method carried out by the section trace tool to reset the configuration of each CPG along a line (step 88 of FIG. 2) is shown. At step 160, the section trace tool sets a flag to false, as described above with reference to step 100 of FIG. 4. At step 162, the section trace tool logs into the first network element, which will be the network element identified by the network engineer during initiation at step 82 of FIG. 2.

For each upstream CPG and each downstream CPG, the section trace tool resets the configuration of the CPG to the original user configuration by issuing an “stm” command and an “stf” command, as described above with respect to step 118. The Section Trace Mode value 108 and the Section Trace Format value 110 provided by the section trace tool are the original user values that were determined at step 106 of FIG. 4. The section trace tool also resets the 16-Byte Transmit Section Trace value 112 by issuing a “txst” command, as described above with reference to step 120 of FIG. 4. The value of the 16-Byte Transmit Section Trace value 112 provided by the section trace tool is the original user value that was determined at step 106 of FIG. 4.

At step 166 the section trace tool logs out of the network element. At step 168 the section trace tool determines whether the value of the flag is true, in order to determine whether the configuration of each CPG along the line has been reset. If the value of the flag is false (i.e. the configurations of the CPGs along the line have not all been reset), then at step 170 the section trace tool logs in to the next upstream network element as determined from the topology.

At step 172 the section trace tool determines whether the network element to which it is currently logged in is an LTE, as described above with reference to step 128 of FIG. 4. If the section trace tool determines at step 172 that this network element is an LTE, then this network element is the last network element of the line, and the section trace tool sets the value of the flag to be true at step 174. The section trace tool then resets the configuration of each CPG in this network element by returning to step 164. If the section trace tool determines at step 172 that this network element is not an LTE, then the section trace tool resets the configuration of each CPG in this network element by returning to step 164, without changing the value of the flag.

After the section trace tool has reset the configuration of the CPGs in the last network element in the line, the value of the flag will be false at step 168, and the section trace tool will have finished resetting the configurations of the CPGs in all the network elements along the line. Determination of fiber connectivity along the entire line is then complete.

Once the fiber connectivity along a line is determined, the network engineer runs the display tool to format and display the fiber connectivity data gathered during the method of FIG. 4, 7 and 8. Referring to FIG. 9, a data structure used to display section trace information for a selected network element is shown. The data structure includes equipment information 250 which relates to the selected network element, and section trace information 252 for each CPG within the selected network element. The section trace information 252 is divided into n section trace blocks 260, one for each of n downstream CPGS, and n section trace blocks 262, one for each of n upstream CPGs. The data structure may also include facility, optical and payload (FOP) information 254 which relates to the transmitters and receivers of each CPG within the network element. The FOP information 254 may be divided into n FOP blocks 264, one for each of n downstream CPGS, and n FOP blocks 266, one for each of n upstream CPGs. Each FOP block 264 and 266 is further divided into a transmitter FOP block 268 and a receiver FOP block 270.

The organization of the section trace information into two sets of section trace blocks 260 and 262 allows the data structures for two neighbouring network elements to be viewed alongside each other in such a way that a network engineer can readily see the connections between the individual CPGs through which the two network elements are interconnected. The network engineer can provide as input to the display tool an identification of a first selected network element and of a second selected network element between which the network engineer wishes to view the interconnections. Referring to FIG. 10, an example of data structures for each of two network elements in a four fiber section is shown. The data structures shown are for NE2 and NE3 of FIG. 1, but with the fibers between NE2 and NE3 crossed. A first data structure 280 provides information relating to NE2, and a second data structure 282 provides information relating to NE3. In FIG. 10, only the section trace information 252 in each data structure is shown in detail.

Each section trace block includes a CPG identifier 284, a 16-Byte Transmit value 290, and a 16-Byte Actual Received value 292. These values are populated by the display tool by reading the datafile generated by the section trace tool. Each section trace block may also include a Section Trace Status 286 and a Section Trace Format 288 so that a network engineer can verify that the correct values were entered by the section trace tool. The 16-Byte Transmit value 290 and the 16-Byte Actual Received value 292 are displayed so that a network engineer can tell at a glance which CPGs in one network element are connected to which CPGs in an adjacent network element. Comparing the 16-Byte Transmit value 290 with the 16-Byte Actual Receive value 296, it can be readily seen that CPG G2 in NE2 is connected to CPG G2E in NE3. Similarly a comparison of the 16-Byte Transmit value 298 with the 16-Byte Actual Received value 304 indicates that CPG G4 in NE2 is connected to CPG G1E in NE3. The crossed fibers are readily noticeable by the network engineer, who now knows the network element and the CPGs between which the fibers are crossed.

In FIG. 10, the section trace blocks 306 and 308 do not contain any values, because NE2 is the first LTE of the line. Section trace blocks 310 and 312 would normally include section trace information for the section from NE3 to NE4, but this information has been omitted from FIG. 10 for the sake of clarity.

The section trace tool and the display tool may be incorporated into a single computer program. In such an embodiment, the section trace tool could populate the section trace information 252 of FIG. 9 as it determines the fiber connectivity along each section, by storing the 16-Byte Transmit Section Trace values and the 16-Byte Actual Received Section Trace values in memory rather than in a datafile. The section trace tool may also gather the equipment information 250 and the FOP information 254 as it determines fiber connectivity. The display tool would then be launched automatically upon completion of the section trace tool, so that the network engineer need not run two separate programs.

The section trace tool and the display tool are each, or together, embodied as software residing on a general purpose computer. The software can be provided on any suitable computer-readable medium, such as a hard disk, a CDROM, or a floppy disk.

The step of storing (step 106 of FIG. 4) and resetting (step 88 of FIG. 2) the original user configuration of each CPG may be omitted if the section trace tool need not be non-intrusive. These steps are advantageous if the configurations set by the user of the network elements are to be preserved following the determination of the fiber connectivity between the network elements, but may be omitted otherwise.

The invention has been described with respect to a Section Trace Format 110 having a value of “16Byte”. Alternatively, the section trace identifier value may be only one byte in length. In such an embodiment, the value of the Section Trace Format 110 may be left as “1Byte”, and step 118 need not set the value of the Section Trace Format 110. However, less identifying information can be included if the section trace identifier value has a length of only one byte.

Methods described by flowcharts which are logically equivalent to the flowcharts described above are within the scope of the present invention. For example, a loop which counts the number of network elements in the line may be used to determine when the upstream LTE is reached, rather than using a flag (as in step 124, 128, and 132 of FIG. 4). As another example, steps 84, 86, and 88 may be performed for each section in turn, rather than for the entire line all at once.

What has been described is merely illustrative of the application of the principles of the invention. Other arrangements and methods can be implemented by those skilled in the art without departing from the spirit and scope of the present invention.

We claim:

1. A computer program product for determining fiber connectivity along a line of a Synchronous Optical Network, the line having at least two network elements (NEs), each NE having at least one Circuit Pack Group (CPG), the computer program product comprising a computer-readable medium including:
instructions for configuring each CPG to enable section tracing;
instructions for populating a section trace transmit value of each CPG with a section trace identifier value unique to the CPG; and
instructions for reading a section trace received value of each CPG.

2. The computer program product of claim 1 wherein the computer-readable medium further includes instructions for setting a section trace format of each CPG to be sixteen bytes, and wherein each section trace identifier value unique to a CPG is a character string identifying the NE to which the CPG belongs, the CPG, and a wavelength associated with the CPG.

3. The computer program product of claim 2 wherein the section trace identifier value unique to each CPG is a fifteen character string comprising seven characters which identify the NE to which the CPG belongs, five characters which identify the CPG, and three characters which identify the wavelength associated with the CPG.

4. The computer program product of claim 1 wherein each CPG has an original user configuration, and the computer-readable medium further includes:
instructions for determining the original user configuration of each CPG;
instructions for storing the original user configuration of each CPG; and
instructions for resetting the original user configuration of each CPG.

5. The computer program product of claim 2 wherein each CPG has an original user configuration, and the computer-readable medium further includes:
instructions for determining the original user configuration of each CPG;
instructions for storing the original user configuration of each CPG; and
instructions for resetting the original user configuration of each CPG.

6. The computer program product of claim 1 wherein the computer-readable medium further includes instructions for receiving as input an identification of a first network element of the line.

7. The computer program product of claim 4 wherein the computer-readable medium further includes instructions for receiving as input an identification of a first network element of the line.

8. The computer program product of claim 1, wherein the computer-readable medium further includes:
instructions for storing the section trace transmit value of each CPG; and
instructions for storing the section trace received value of each CPG.

9. The computer program product of claim 8, wherein the computer-readable medium further includes:
instructions for receiving as input an identification of a first selected NE;
instructions for reading the stored section trace transmit value of each CPG which belongs to the first selected NE;
instructions for reading the stored section trace received value of each CPG which belongs to the first selected NE;
instructions for displaying equipment information which identifies the first selected NE; and
instructions for displaying section trace information comprising at least one section trace block, each section trace block corresponding to one CPG in the first selected NE, each section trace block including the section trace transmit value and the section trace received value of the CPG to which the section trace block corresponds.

10. The computer program product of claim 9 wherein each CPG is either an upstream CPG or a downstream CPG, and wherein the section trace blocks are arranged so that the section trace blocks corresponding to upstream CPGs appear on a first side of the section trace information and the section trace blocks corresponding to downstream CPGs appear on a second side of the section trace information.

11. A method of displaying fiber connectivity between a first network element (NE) and a second NE of a Synchronous Optical Network, each NE including at least one Circuit Pack Group (CPG), each CPG being either an upstream CPG or a downstream CPG, the method comprising the steps of:
reading a section trace transmit value of each CPG of the first NE;
reading a section trace received value of each CPG of the first NE;
displaying equipment information which identifies the first NE; and
displaying section trace information comprising at least one section trace block, each section trace block corresponding to one CPG in the first NE, each section trace block including the section trace transmit value and the section trace received value of the CPG to which the section trace block corresponds, and the section trace blocks being arranged so that the section trace blocks corresponding to upstream CPGs appear on a first side of the section trace information and section trace blocks corresponding to downstream CPGs appear on a second side of the section trace information.

12. The method of claim 11 comprising the further step of displaying equipment information and section trace information for the second NE alongside the equipment information and the section trace information for the first NE.

13. A computer program product for displaying fiber connectivity between a first network element (NE) and a second NE of a Synchronous Optical Network, each network element including at least one Circuit Pack Group (CPG), each CPG being either an upstream CPG or a downstream CPG, the computer program product comprising a computer-readable medium including:
instructions for reading a section trace transmit value of each CPG in the first NE;
instructions for reading a section trace received value of each CPG of the first NE;
instructions for displaying equipment information which identifies the first NE; and
instructions for displaying section trace information comprising at least one section trace block, each section trace block corresponding to one CPG in the first NE, each section trace block including the section trace transmit value and the section trace received value of the CPG to which the section trace block corresponds, and the section trace blocks being arranged so that the section trace blocks corresponding to upstream CPGs appear on a first side of the section trace information and section trace blocks corresponding to downstream CPGs appear on a second side of the section trace information.

14. The computer program product of claim 13 wherein the computer-readable medium further includes instructions for displaying equipment information and section trace information for the second NE alongside the equipment information and the section trace information for the first NE.
